(19) United States
(12) Patent Application Publication
(10) Pub. No.: US 2021/0086815 A1
(43) Pub. Date: Mar. 25, 2021

(54) CART SUSPENSION

(71) Applicant: Suncast Technologies, LLC, Palm Beach Gardens, FL (US)

(72) Inventors: Robert G. Kopp, Elburn, IL (US); Kent J. Martin, Geneva, IL (US); Stephen Whitehead, Elgin, IL (US)

(21) Appl. No.: 16/582,456

(22) Filed: Sep. 25, 2019

(51) Int. Cl. B62B 5/00; B62B 3/00

(52) U.S. Cl. CPC B62B 5/00; B62B 2301/20; B62B 2301/044; B62B 3/00

(57) ABSTRACT

A cart suspension device or system, or a castor equipped cart or platform having such a cart suspension system or device which reduces noise and vibrations when in use. The cart suspension device or system, or castor equipped cart or platform having such a cart suspension system or device utilizes a swing arm or a one-piece spring bracket and a shock pneumatic rubber damper to greatly reduce the noise and vibration inherent in carts rolling over uneven surfaces.

### FIELD OF THE INVENTION

The present invention relates to castor equipped carts or platforms; to systems and devices for reducing noise or vibrations created by carts or platforms equipped with castors; and more particularly, more cart suspension devices or systems which reduce noise and vibrations when in use, or to castor equipped carts or platforms having such carts suspensions.

### BACKGROUND OF THE INVENTION

Carts or platforms are well known devices used to move loads that cannot be easily transported by hand. A typical cart or platform includes a generally rectangular, flat, material-supporting surface having two swivel casters positioned at the rear end of the carts or platforms, and two unidirectional, non-swiveling wheels at the front end of the carts or platforms. U.S. Pat. No. 9,650,060 illustrates an example of a platform having a typical supporting surface and use of castors. U.S. Pat. No. 9,840,265 provides an illustrative example of a luggage cart having a supporting surface, movable by a plurality of castors. While such carts are very useful in moving loads, such castor equipped carts or platforms can produce noise as they move. Rolling platforms and carts vibrate when traversing uneven floor surfaces like tile floors or outdoor pavement. This vibration produces a measure of noise as the units pick up the vibration and amplify the sound. Depending on the contents of the cart or platform, the load may further amplify the vibration to a loud noise range.

Therefore, what is needed in the arts is castor equipped carts or platforms with reduced noise and vibration that provide reduction in noise and vibrations inherent in the carts or platforms rolling over uneven surfaces.

### SUMMARY OF THE INVENTION

The present invention relates to cart suspension devices or systems which reduce noise and vibrations when in use, or to castor equipped carts or platforms having such cart suspension systems or devices. The present invention was developed to reduce the amount of noise created by a caster equipped cart or platform. The cart suspension device or system, or castor equipped carts or platforms having such a cart suspension system or device, utilize a swing arm or a one-piece spring bracket and a shock pneumatic rubber damper to greatly reduce the noise and vibration inherent in carts rolling over uneven surfaces. The caster utilizes a wheel with a bearing around the axle bolt. Without a bearing, the bolt must remain loose enough for the wheel to turn freely. By using a bearing, the axle bolt can be tightened, thus eliminating noise resulting from wheel movement. The caster may also incorporate a low durometer (softer) tire made of polyurethane. The polyurethane tire remains durable, while allowing for a measure of sound and vibration damping. Small magnitude vibration is dampened by the soft durometer tire, while large magnitude vibration is dampened by the swing arm and a shock ball suspension.

The cart suspension device or system, or castor equipped carts or platforms having such a cart suspension system or device are an improvement over current carts using castors rigidly fixed to their tray or platform. Such arrangement allows vibrations induced by an uneven floor surface to be transferred to a load being born by the cart or platform. In the case of a restaurant cart being used to transport dishes and glasses, the vibration is further transferred to loads that can produce high noise levels. The cart suspension device or system, or castor equipped carts or platforms having such a cart suspension system or device is designed to effectively isolate wide ranges of vibration from the contents of a rolling cart or platform. By doing so, the cart suspension device or system, or castor equipped carts or platforms having such a cart suspension system or device effectively reduces the noise generated by those loads as they no longer amplify vibrations produced from rolling over uneven surfaces.

In one embodiment, a castor equipped cart or platform having a soft ride suspension system comprises: one or more load bearing surfaces designed to hold a load; a plurality of wheels; and a ride suspension system configured to reduce noise and vibration from said castor equipped cart or platform when said castor equipped cart or platform is moving or rolling over uneven surfaces.

In another embodiment, a soft ride suspension system for use with a movable structure, such as a castor equipped cart or platform comprises: a spring bracket; and a damping structure; wherein the soft ride suspension system is configured to isolate wide ranges of vibration from contents placed on the cart or platform when moving or rolling, thereby reducing noise generated by the loads as the loads no longer amplify vibrations produced from rolling over uneven surfaces.

Accordingly, it is an objective of the invention to provide cart suspension devices or systems for use with castor equipped carts or platforms.

It is yet another objective of the invention to provide cart suspension devices or systems for use with castor equipped carts or platforms which reduce noise and vibrations when in use.

It is a further objective of the invention to provide castor equipped carts or platforms having cart suspension devices or systems.

It is a still further objective of the invention to provide castor equipped carts or platforms having cart suspension devices or systems which reduce noise and vibrations when in use.

It is a further objective of the invention to teach a device designed to reduce the amount of noise created by a caster equipped cart or platform.

It is yet another objective of the invention to provide a cart suspension device or system which effectively reduces the noise generated by loads carried thereon, as they no longer amplify vibrations produced from rolling over uneven surfaces.

It is a still further objective of the invention to provide a castor equipped cart or platform having a cart suspension system or device which effectively reduces the noise generated by loads carried thereon, as they no longer amplify vibrations produced from rolling over uneven surfaces.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of an illustrative example of a castor equipped cart with a soft ride suspension system;

FIG. 2 is an exploded view of the castor equipped cart with a soft ride suspension shown in FIG. 1;

FIG. 3 is a perspective view of a castor assembly with a soft ride suspension system;

FIG. 4 is an alternative perspective view of the castor assembly with a soft ride suspension system;

FIG. 5 is a perspective view of the one-piece spring bracket;

FIG. 6 is an alternative perspective view of the one-piece spring bracket;

FIG. 7 is an alternative perspective view of the one-piece spring bracket;

FIG. 8 is a top view of the castor equipped cart with a soft ride suspension system;

FIG. 9 is a view taken along lines 8A-8A in FIG. 8; and

FIG. 10 is a cross sectional view of the castor assembly and soft ride suspension system included in the broken line circle shown in FIG. 9.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

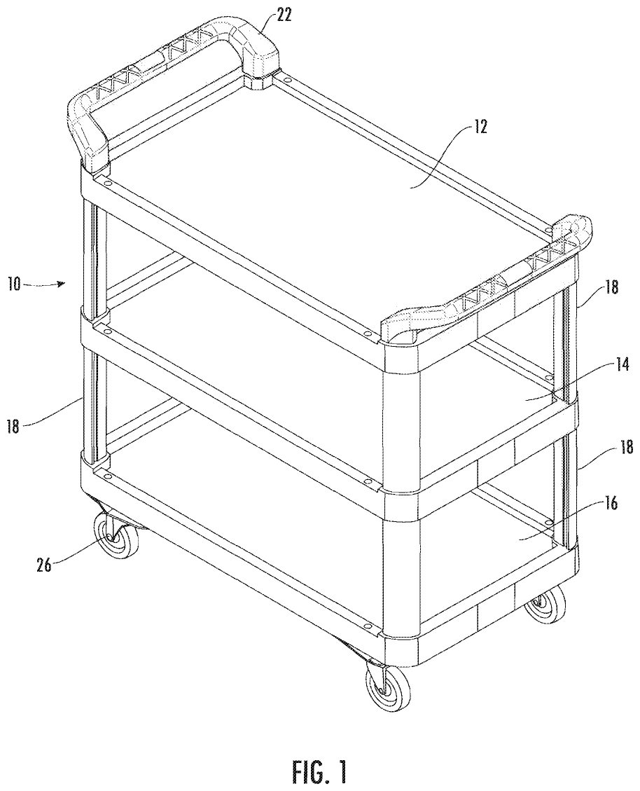

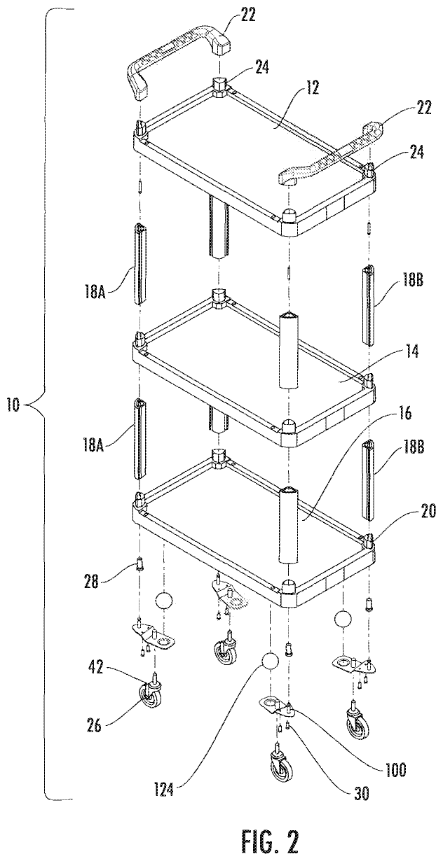

Referring to FIG. 1 or FIG. 2, an illustrative example of a castor equipped cart 10 is shown. The cart has a plurality of load bearing surfaces 12, 14, and 16, each designed to hold a load. Each side of the castor equipped cart 10 contains a plurality of corner posts 18A or 18B, locked to post locking member 20 (see FIG. 2). The castor equipped cart 10 may be pushed by handle 22, secured to the castor equipped cart 10 via handle securing members 24. The castor equipped cart 10 is moved from one place to another with the aid of multiple castor assemblies 26 secured to the bottom surface of the castor equipped cart 10 via a castor socket 28 (FIG. 2). The castor equipped cart 10 is equipped with a soft ride suspension, referred to generally as a cart suspension assembly 100, secured to the bottom surface of the castor equipped cart 10 via fastening members, such as screws 30. The cart suspension assembly 100 is configured to reduce noise and vibrations associated with the castor equipped cart when in use, i.e. moving in general or moving over uneven surfaces.

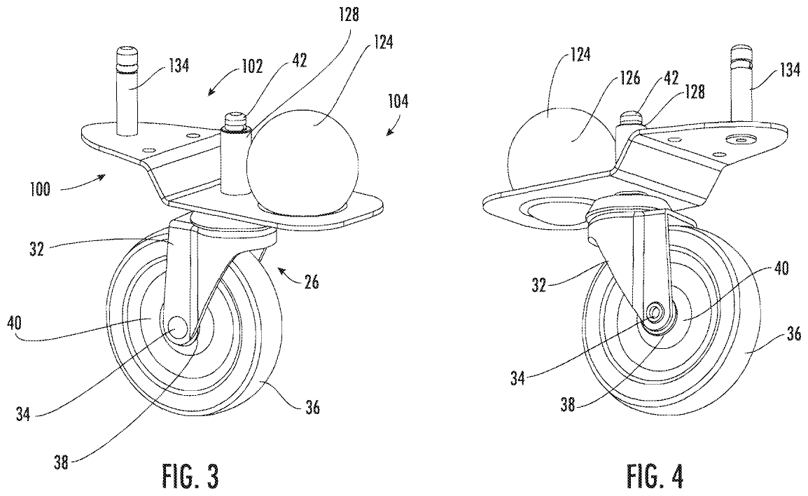

Referring to FIGS. 3 and 4, the cart suspension assembly 100 is shown secured to the castor assembly 26. The castor assembly 26 includes a fork 32, axle shaft 34, wheel/tire 36, bearing 38, wheel center 40, and pin 42. The caster assembly 100 may also incorporate a low durometer, for example Shore A 60 durometer, (softer) tire 36 made of polyurethane. The cart suspension assembly 100 includes a bracket 102 and a damping structure or member 104. The bracket 102 is preferably a swing arm or a one-piece spring bracket. Preferably, the damping structure or member 104 is a pneumatic rubber damper.

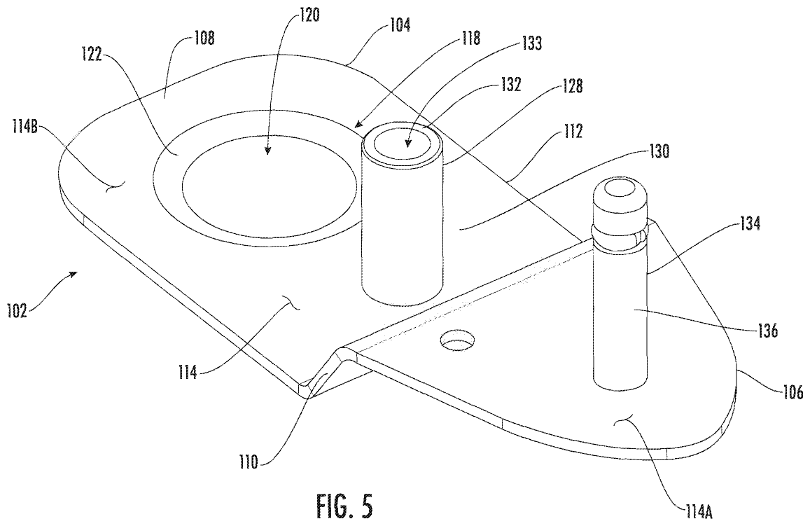

Referring to FIGS. 5-8, the bracket 102 is shown as a preferred embodiment, one-piece spring bracket 102. The one-piece spring bracket 102 comprises a first end portion 106, a second end portion 108, and an intermediate portion 110 linking the first end portion 106 and the second end portion 108. The first end portion 106, the second end portion 108, and the intermediate portion 110 thus forming the one-piece spring bracket body 112. The one-piece spring bracket body 112 comprises a first surface 114, which faces the castor equipped cart 10 when installed thereon, and a second opposing surface 116, which faces the ground or surface on which the castor equipped cart 10 moves or rests upon. The first surface 114 may further be defined by the first end portion first surface 114A, the second end portion first surface 114B, and the intermediate portion first surface 114C. The second opposing surface 116 may further be defined by the first end portion second surface 116A, the second end portion second surface 116B, and the intermediate portion second surface 1160.

The intermediate portion 110 is preferably angled relative to the first end portion 106 and the second end portion 108, such as, for example, greater than zero (0) degrees and at or less than ninety (90) degrees. Alternatively, the intermediate portion may be angled at any degree greater than ninety (90) degrees. In either configuration, having the intermediate portion 110 angled provides for the first end portion 106 to be orientated or arranged in a higher position or at a different plane relative to the second end portion 108.

The one-piece spring bracket body 112 preferably comprises a damping structure engaging component or structure 118, preferably located within the second end portion 108. The damping structure engaging component or structure 118 is designed to interact or engage with the damping structure or member 104. As illustrated in FIGS. 5-8, the damping structure engaging component or structure 118 comprises an opening 120 bordered by a continuous wall or surface 122. The continuous wall or surface 122 may have a shape and/or be angled. In an illustrative embodiment, the continuous wall or surface 122 is shaped to correspond with or mirror the shape of the damping structure or member 104.

As illustrated in FIGS. 3 and 4, the damping structure or member 104 is shown as a spherical ball 124. The spherical ball may also be referred to as a spherical shock absorber 124. The spherical ball or spherical shock absorber 124 is preferably a pneumatic rubber ball acting as a damper to reduce the noise and vibration of the castor equipped cart 10 as the castor equipped cart 10 moves over a surface, particularly as it rolls over uneven surfaces, such as tiled floors or outdoor pavements. When in use, the spherical ball 124 is placed inside the opening 120 so that at least a portion of an outer surface 126 of the spherical ball 124 rests against or is secured within the continuous wall or surface 122.

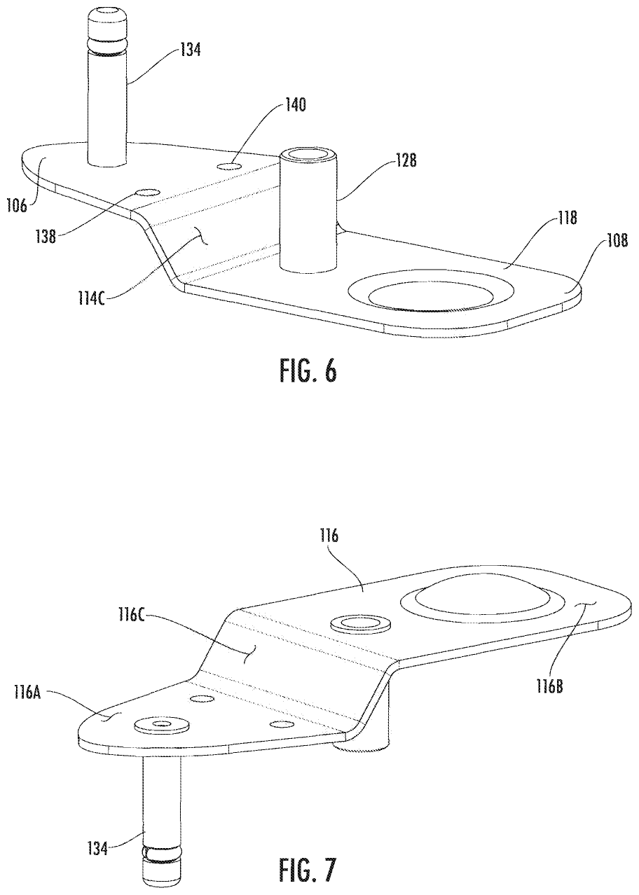

Extending upwardly and away from the first surface 114 of the one-piece spring bracket 102 is a caster bushing 128. The caster bushing 128 is shown having a generally cylindrical body 130 which terminates in an opening 132. The generally cylindrical body 130 has a hollow interior 133 sized and shaped to receive the castor assembly pin 42 therein. As shown in FIGS. 5 and 6, the one-piece spring bracket 102 may also comprise a castor stem anchor 134. The castor stem anchor 134 is shown positioned within the first end portion 106, extending upwardly and away from the first end portion first surface 114A. The castor stem anchor 134 is shown having a generally cylindrical body 136 and is sized and shaped to be inserted within a socket (described below). The caster bushing 128 or the castor stem anchor 134 may be integrally formed with the one-piece spring bracket 102. Alternatively, the caster bushing 128 or the castor stem anchor 134 may be formed separately and secured to the one-piece spring bracket 102 using, for example, mechanical fastening mechanisms, such as the use of screws and washers, chemical securing compounds, such as glue, or other known securing mechanisms. The one-piece spring bracket 102 may be secured to the castor equipped cart 10 using fastening members, such as screws 30, inserted within openings 138 and 140.

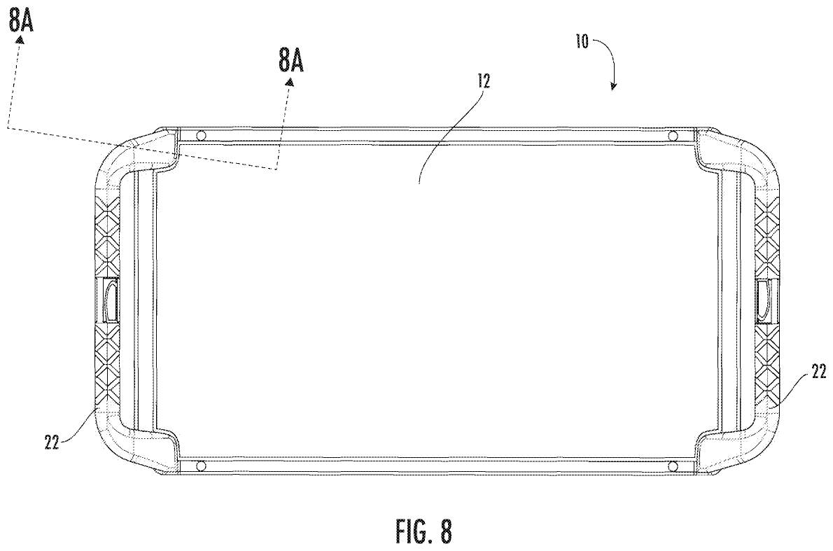

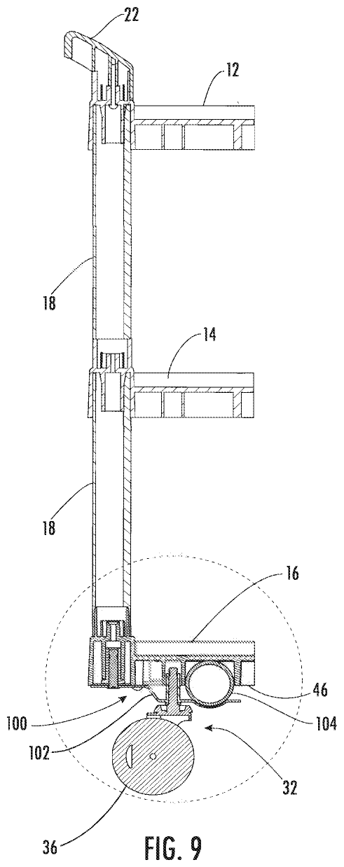

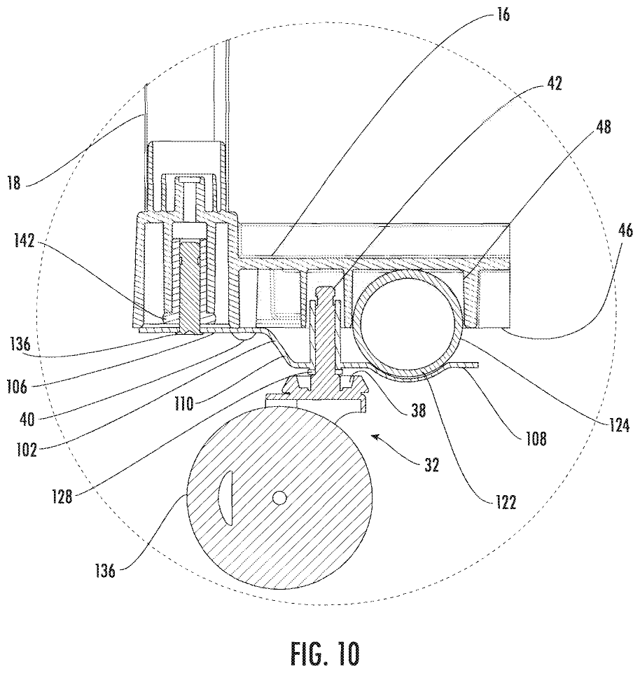

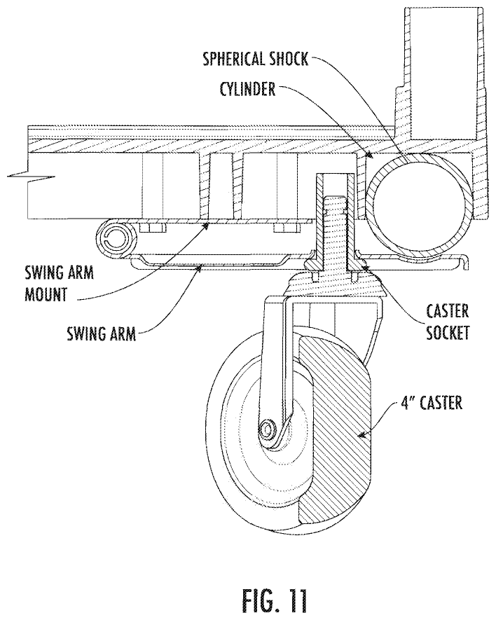

Referring to FIGS. 8-10, the cart suspension assembly 100 is shown secured to the bottom surface 46 of the castor equipped cart 10. The one-piece spring bracket 102 is secured to the bottom surface 46 of the castor equipped cart 10 via one or more screws 30 so that the second end portion 108 is aligned with and engages the spherical ball 124. In this arrangement, the caster stem anchor 134 is inserted into a castor socket 142. As illustrated in FIG. 10, the spherical ball 124 is inserted into the damping structure receiving area 48, illustrated as a cut out area of the bottom surface 46 of the castor equipped cart 10. As described previously, the spherical ball 124 is secured to the continuous wall or surface 122, thus maintaining the spherical ball 124 in place. When in use, the one-piece spring bracket 102 is designed to act as a spring with a pivot point. The one-piece spring bracket 102 may also have damping capabilities. In addition to its damping functioning, the spherical ball 124 may act as a secondary spring which is mounted on the side of the wheel 36.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A castor equipped cart or platform having a soft ride suspension system comprising:
one or more load bearing surfaces designed to hold a load;
a plurality of wheels;
a ride suspension system configured to reduce noise and vibration from said castor equipped cart or platform when said castor equipped cart or platform is moving or rolling over uneven surfaces.

2. The castor equipped cart or platform having a soft ride suspension system according to claim 1, wherein said wheels are castor assemblies.

3. The castor equipped cart or platform having a soft ride suspension system according to claim 1, wherein said soft ride suspension system comprises a spring bracket comprising a first end portion, a second end portion, and an intermediate portion linking said first end portion and said second end portion;

4. The castor equipped cart or platform having a soft ride suspension system according to claim 2, wherein said soft ride suspension system comprises a damping structure.

5. The soft ride suspension system for use with the castor equipped cart or platform according to claim 4, wherein said one-piece spring bracket body comprises a damping structure engaging structure configured to interact or engage with said damping structure.

6. The soft ride suspension system for use with the castor equipped cart or platform according to claim 4, wherein said damping structure is a spherical shock absorber.

7. The soft ride suspension system for use with the castor equipped cart or platform according to claim 6, wherein said spherical shock absorber is a pneumatic rubber ball acting as a damper to reduce noise and vibration of said castor equipped cart as said castor equipped cart moves over an even surface or an uneven surface.

8. The castor equipped cart or platform having a soft ride suspension system according to claim 1, wherein said castor equipped cart or platform comprises a bottom surface having one or more damping structure receiving areas sized and shaped to receive at least one damping structure.

9. The castor equipped cart or platform having soft ride suspension system according to claim 2, wherein said castor assembly includes a low durometer tire.

10. The castor equipped cart or platform having a soft ride suspension system according to claim 9, wherein said tire is made of polyurethane.

11. A soft ride suspension system for use with a castor equipped cart or platform comprising:
a spring bracket; and
a damping structure;
wherein said soft ride suspension system is configured to isolate wide ranges of vibration from contents placed on said cart or platform when moving or rolling, reducing noise generated by said loads as said loads no longer amplify vibrations produced from rolling over uneven surfaces.

12. The soft ride suspension system for use with the castor equipped cart or platform according to claim 11, wherein said spring bracket is a one-piece spring bracket comprising a first end portion, a second end portion, and an intermediate portion linking said first end portion and said second end portion.

13. The soft ride suspension system for use with the castor equipped cart or platform according to claim 12, wherein said one-piece spring bracket body comprises a damping structure engaging structure configured to interact or engage with said damping structure.

14. The soft ride suspension system for use with the castor equipped cart or platform according to claim 13, wherein said damping structure is a spherical shock absorber.

15. The soft ride suspension system for use with the castor equipped cart or platform according to claim 14, wherein said spherical shock absorber is a pneumatic rubber ball acting as a damper reduce noise and vibration of said castor equipped cart as said castor equipped cart moves over an even surface or an uneven surface.

16. The soft ride suspension system for use with the castor equipped cart or platform according to claim 11, wherein said one-piece spring bracket body comprises a castor bushing sized and shaped to receive a castor assembly pin.

17. The soft ride suspension system for use with the castor equipped cart or platform according to claim 16, wherein said one-piece spring bracket body comprises a castor stem anchor.
